(19) United States
(12) Patent Application Publication
(10) Pub. No.: US 2012/0127272 A1
(43) Pub. Date: May 24, 2012

(54) 3D IMAGE CAPTURING DEVICE AND METHOD

(75) Inventor: Kun-Hui LAI, TAIPEI CITY (TW)

(73) Assignee: INVENTEC CORPORATION, TAIPEI CITY (TW)

(21) Appl. No.: 12/982,888

(22) Filed: Dec. 31, 2010

(30) Foreign Application Priority Data
Nov. 18, 2010 (CN) 201010564143.7

(51) Int. Cl. H04N 13/02

(52) U.S. Cl. 348/46; 348/E13.074

(57) ABSTRACT

A 3D image capturing device includes a first light incident hole, a second light incident hole, a photosensitive element, and a processing unit. The photosensitive element is located at an intersection point between a first light path formed by the first light incident hole and a second light path formed by the second light incident hole. The processing unit includes a 3D image sensing module and a 3D image synthesizing module. The 3D image sensing module enables the photosensitive element to alternately sense at least one first image and at least one second image. The first image is sensed by the photosensitive element through the first light path and the second image is sensed by the photosensitive element through the second light path. The 3D image synthesizing module synthesizes alternate first image and second image to generate at least one 3D image.

### RELATED APPLICATIONS

This application claims priority to China Application Serial Number 201010564143.7, filed Nov. 18, 2010, which is herein incorporated by reference.

### BACKGROUND

1. Field of Invention

The present invention relates to a three-dimensional (3D) image capturing device and a 3D image capturing method. More particularly, the present invention relates to a device and a method using one single photosensitive element to capture a 3D image.

2. Description of Related Art

Recently, 3D screens have gradually entered the market, and are expected to become mainstream in the two to three years. Thus, corresponding schemes for generating 3D images also are believed to be developed vigorously. Especially, on the audio-visual instant communication software (for example, MSN, ICQ) installed on portable electronic devices (for example, notebook computers or laptop computers) or handheld communication devices (for example, mobile phones), the demands for desiring to see counterpart's 3D images will occur in the future.

Generally speaking, a 3D image is a combination of two images which are respectively transmitted to a user's left and right eyes, thus creating user illusion. Therefore, the method for generating a 3D image is to simulate the way of generating images respectively seen by the user's left and right eyes. Therefore, one of the simplest conventional methods is to install two image capturing lenses which are spaced about 6 cm apart on an electronic device, so as to respectively simulate the images seen by the user's left and right eyes.

However, the installation of two photosensitive elements causes additional hardware cost.

### SUMMARY

Therefore, an aspect of the present invention is to provide a 3D image capturing device used for enabling one single photosensitive element to alternately sense images through two light incident holes and for synthesizing the alternately sensed images to generate a 3D image. The 3D image capturing device includes a first light incident hole, a second light incident hole, a photosensitive element, and a processing unit. The photosensitive element is located at an intersection point between a first light path formed by the first light incident hole and a second light path formed by the second light incident hole. The processing unit is electrically connected to the photosensitive element. The processing unit includes a 3D image sensing module and a 3D image synthesizing module. The 3D image sensing module enables the photosensitive element to alternately sense at least one first image and at least one second image. The first image is sensed by the photosensitive element through the first light path and the second image is sensed by the photosensitive element through the second light path. The 3D image synthesizing module synthesizes alternate first image and second image to generate at least one 3D image.

Another aspect of the present invention is to provide a 3D image capturing method, wherein one single photosensitive element is used to alternately sense images through two light incident holes and synthesize the alternately sensed images to generate a 3D image. The 3D image capturing method includes: forming a first light path through a first light incident hole and forming a second light path through a second light incident hole, wherein the one single photosensitive element is disposed at an intersection point between the first light path and the second light path, and is used to alternately sense at least one first image and at least one second image. The first image is sensed through the first light path, and the second image is sensed through the second light path. Then, alternate first image and second image are synthesized to generate at least one 3D image.

As seen from the above embodiments of the present invention, the present invention has the following advantages. Only one photosensitive element is required to be disposed to generate a 3D image. Therefore, the number of photosensitive elements required for capturing 3D images is reduced, thus reducing the cost. Furthermore, when there are a plurality of first images and a plurality of second images sensed by the photosensitive element, the respective first images and the second images corresponding thereto are sequentially synthesized to form a plurality of 3D images, thereby forming a 3D image stream.

### BRIEF DESCRIPTION OF THE DRAWINGS

The invention can be more fully understood by reading the following detailed description of the embodiment, with reference made to the accompanying drawings as follows:

FIG. 1 is a functional block view of a 3D image capturing device according to an embodiment of the present invention;

FIG. 2 illustrates the 3D image capturing device shown in FIG. 1 according to an embodiment of the present invention; and

FIG. 3 is a flow chart showing a 3D image capturing method according to an embodiment of the present invention.

### DETAILED DESCRIPTION

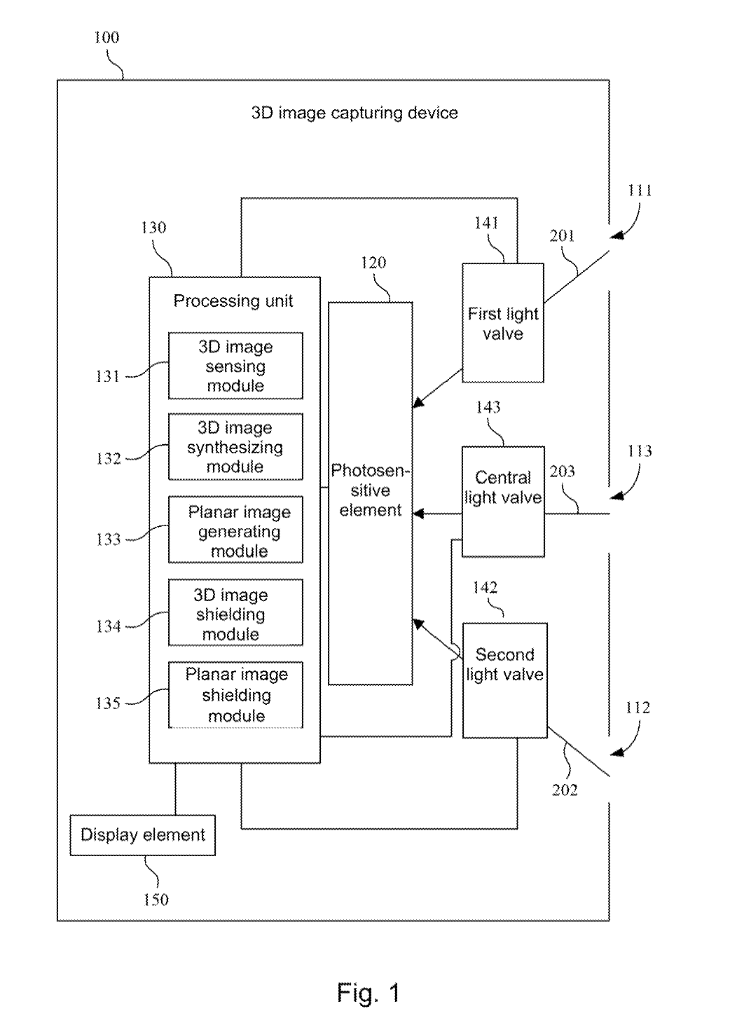

FIG. 1 is a functional block view of a 3D image capturing device 100 according to an embodiment of the present invention. Referring to FIG. 1, the 3D image capturing device 100 uses one single photosensitive element to alternately sense images through two light incident holes and synthesizes the alternately sensed images to generate a 3D image.

The 3D image capturing device 100 includes a first light incident hole 111, a second light incident hole 112, a photosensitive element 120, and a processing unit 130. The photosensitive element 120 is located at an intersection point between a first light path 201 formed by a first light incident hole 111 and a second light path 202 formed by a second light incident hole 112. At least one refractor, at least one lens, at least one reflector, or a combination thereof, or other light directing elements can be disposed on the first light path 201, so as to direct light from the first light incident hole 111 to the photosensitive element 120. At least one refractor, at least one lens, at least one reflector, or a combination thereof, or other light directing elements may be can be disposed on the second light path 202, so as to direct light from the second light incident hole 112 to the photosensitive element 120. Thus, in other embodiments, different refractors, lenses, or reflectors can be used to form the first light path 201 and the second light path 202 differently towards the photosensitive element 120, which are not limited to this disclosure.

The processing unit 130 is electrically connected to the photosensitive element 120. The processing unit 130 includes a 3D image sensing module 131 and a 3D image synthesizing module 132. The 3D image sensing module 131 enables the photosensitive element 120 to alternately sense at least one first image and at least one second image. The first image is sensed by the photosensitive element 120 through the first light path 201, and the second image is sensed by the photosensitive element 120 through the second light path 202. The 3D image synthesizing module 132 synthesizes alternate first image and second image to generate at least one 3D image. In other words, the 3D image synthesizing module 132 takes the first image and the second image sensed at consecutive time points as the images respectively seen by two eyes, and synthesizes the images to generate a 3D image. In this manner, only one photosensitive element 120 is required to generate the 3D image. Therefore, the number of photosensitive elements required for capturing the 3D images is reduced, thus reducing the cost. Moreover, when a plurality of first images and a plurality of second images are sensed by the photosensitive element 120, the 3D image synthesizing module 132 synthesizes the first images and the second images correspondingly to generate a plurality of 3D images, thereby forming a 3D image stream.

Light valves can be used to alternately shield the first light path 201 and the second light path 202 for enabling the photosensitive element 120 to alternately sense the first images and the second images. Therefore, the 3D image capturing device 100 may further include a first light valve 141 and a second light valve 142. The first light valve 141 is located on the first light path 201, and the second light valve 142 is located on the second light path 202. The first light valve 141 and the second light valve 142 are respectively electrically connected to the processing unit 130. Moreover, shutters, liquid crystal light valves or another type of light valves may be used as the first light valve 141 and the second light valve 142. Hence, the 3D image sensing module 131 enables the first light valve 141 and the second light valve 142 to alternately shield the first light path 201 and the second light path 202, so as to enable the photosensitive element 120 to alternately sense at least one first image and at least one second image. Hence, the alternate shieldings using the light valves can make the images sensed by the photosensitive element 120 as formed by the incident light alternately transmitted from the first light incident hole 111 and the second light incident hole 112.

Moreover, the 3D image capturing device 100 may also capture a planar image. Thus, the 3D image capturing device 100 may further include a central light incident hole 113, and the processing unit 130 may further include a planar image generating module 133. The central light incident hole 113 is located between the first light incident hole 111 and the second light incident hole 112. The planar image generating module 133 enables the photosensitive element 120 to sense a planar image through a central light path 203 formed by the central light incident hole 113. In this manner, the planar image offset caused by the planar image captured through the first light incident hole 111 or the second light incident hole 112 can be avoided.

Alternatively, when the planar image is being captured, the first light incident hole 111 and the second light incident hole 112 may be shielded. Thus, the processing unit 130 may further include a 3D image shielding module 134. When the planar image generating module 133 enables the photosensitive element 120 to sense the planar image (i.e. the planar image generating module 133 is in operation), the 3D image shielding module 134 simultaneously drives the first light valve 141 and the second light valve 142 to shield the first light path 201 and the second light path 202 respectively. However, in other embodiments, a removable first shielding piece and a removable second shielding piece may be respectively disposed on the first light path 201 and the second light path 202. When the planar image is being captured, the user may respectively move the first shielding piece and the second shielding piece to the first light path 201 and the second light path 202 to block the light from the first light incident hole 111 and the second light incident hole 112. In this manner, the photosensitive element 120 is protected from being affected by the light transmitted from the first light incident hole 111 and the second light incident hole 112 when being used to capture the planar image.

Moreover, when the 3D image is being captured, the central light incident hole 113 may be shielded. Therefore, the 3D image capturing device 100 may further include a central light valve 143 electrically connected to the processing unit 130, and the processing unit 130 may further include a planar image shielding module 135. The central light valve 143 is located on the central light path 203. If the 3D image synthesizing module 132 is in operation, the planar image shielding module 135 drives the central light valve 143 to shield the central light path 203. However, in other embodiments, a central shielding piece may be removably disposed on the central light path 203. When the 3D image is being captured, the user may move the central shielding piece to the central light path 203 to block the light from entering the central light incident hole 113. In this manner, the photosensitive element 120 is protected from being affected by the light transmitted from the central light incident hole 113 when being used to capture the 3D image.

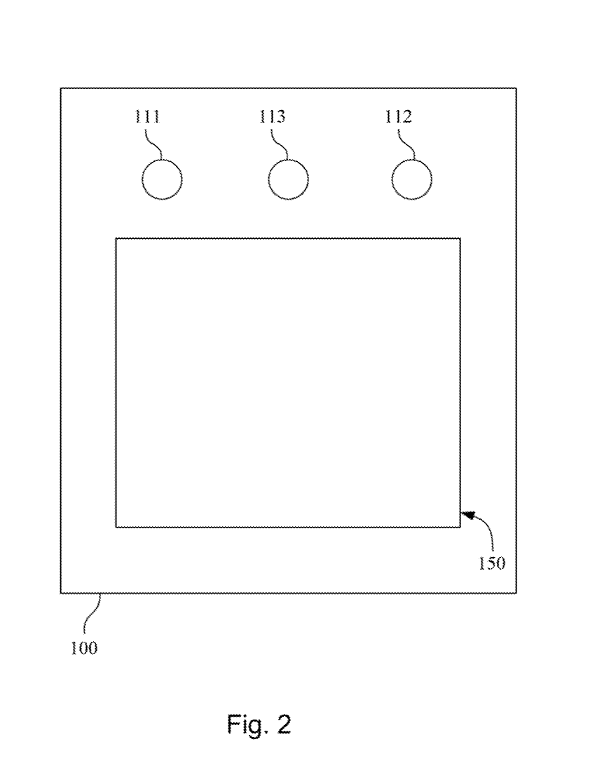

FIG. 2 illustrates the 3D image capturing device 100 shown in FIG. 1 according to an embodiment of the present invention. Referring to both FIG. 1 and FIG. 2, when the 3D image capturing device 100 is applied in a notebook computer, a mobile phone or another electronic device provided with the image capturing function, the first light incident hole 111, the second light incident hole 112, and the central light incident hole 113 may be arranged above a display element 150 of the 3D image capturing device 100. In this manner, the user may hold a video conference with the planar image or 3D image through the light incident holes disposed above the display element 150.

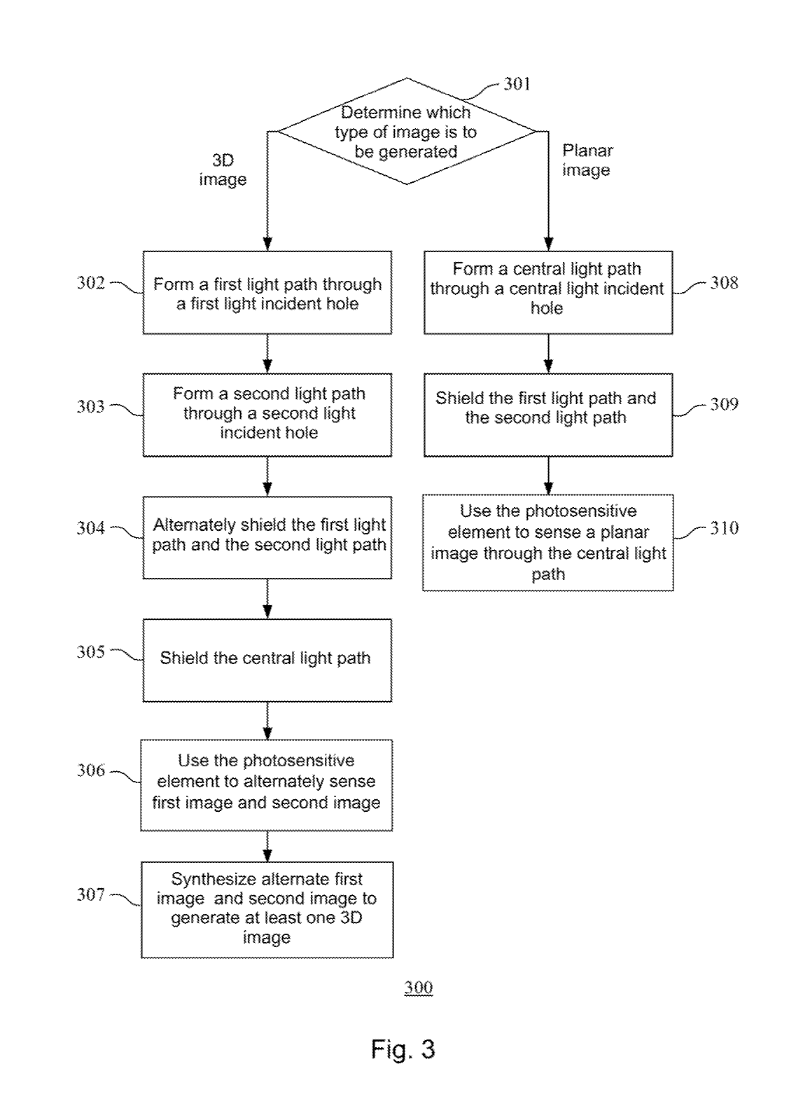

FIG. 3 is a flow chart showing a 3D image capturing method according to an embodiment of the present invention. In a 3D image capturing method 300, a single photosensitive element is enabled to alternately sense images from two light incident holes, and the alternately sensed images are synthesized to generate a 3D image.

The 3D image capturing method 300 includes the following steps.

In Step 302, a first light path is formed through a first light incident hole.

In Step 303, a second light path is formed through a second light incident hole, wherein a photosensitive element is disposed at an intersection point between the first light path and the second light path.

In Step 306, the photosensitive element is used to alternately sense at least one first image and at least one second image. The first image is sensed through the first light path, and the second image is sensed through the second light path.

In Step 307, alternate first image and second image are synthesized to generate at least one 3D image. In other words, in Step 307, the first image and the second image sensed at consecutive time points may be considered as the images respectively seen by two eyes and are synthesized to generate a 3D image. In this manner, only one photosensitive element is needed to generate the 3D image. Hence, the number of photosensitive elements required for capturing the 3D image is reduced, and thus the cost is reduced. Moreover, when a plurality of first images and a plurality of second images are sensed by the photosensitive element, Step 307 can be performed to alternately obtain and synthesize one first image and one second image corresponding thereto to form one 3D image, and thus sequentially forms a plurality of 3D images with respect to all of the first and second images, thereby forming 3D image stream.

The first light path and the second light path are alternately shielded (Step 304) to enable the photosensitive element to alternately sense the first image and the second image (Step 306). A first light valve and a second light valve are respectively disposed on the first light path and the second light path. Shutters, liquid crystal light valves, shielding pieces, or another type of light valves may be used as the first light valve and the second light valve. Hence, the first light valve and the second light valve may be alternately triggered to alternately shield the first light path and the second light path (Step 304). In this manner, the image sensed by the photosensitive element is generated by incident light alternately transmitted from the first light incident hole and the second light incident hole.

Moreover, the 3D image capturing method 300 may also support the photography of planar images. Therefore, the 3D image capturing method 300 may further include the following steps.

In Step 301, it determines which type of image is to be generated.

When a 3D image is desired to be generated, Step 301˜Step 307 are performed to synthesize the 3D image (Step 307). When a planar image is desired to be generated, a central light path is formed through a central light incident hole (Step 308). The central light incident hole is disposed between the first light incident hold and the second light incident hole.

In Step 310, the photosensitive element senses a planar image through the central light path. In this manner, the planar image offsets caused by the planar image captured through the first light incident hole or the second light incident hole can be avoided.

Moreover, when the planar image is being captured, the first light incident hole (the first light path) and the second light incident hole (the second light path) are shielded (Step 309). Shielding pieces, liquid crystal light valves, shutters, or another type of light valves may be used to shield the first light incident hole and the second light incident hole (Step 309). In this manner, the photosensitive element, is protected from being affected by the light transmitted from the first light incident hole and the second light incident hole when being used to capture the planar image.

Moreover, before the first image and the second image are sensed (Step 306), the central light path is shielded (Step 305). A shielding piece, a liquid crystal light valve, a shutter, or another type of light valve may be used to shield the central light path (Step 305). In this manner, the photosensitive element is protected from being affected by the light transmitted from the central light incident hole when being used to capture the 3D image.

As seen from the embodiments of the present invention, the present invention has the following advantages. Only one photosensitive element is needed to generate the 3D image. Hence, the number of photosensitive elements required for capturing the 3D image is reduced, and thus the cost is reduced. Moreover, when a plurality of first images and a plurality of second images are sensed by the photosensitive element, a plurality of 3D images is sequentially generated by synthesization, thereby forming a 3D image stream.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A three-dimensional (3D) image capturing device, comprising:
a first light incident hole;
a second light incident hole;
a photosensitive element located at an intersection point between a first light path formed by the first light incident hole and a second light path formed by the second light incident hole; and
a processing unit electrically connected to the photosensitive element, the processing unit comprising:
a 3D image sensing module for enabling the photosensitive element to alternately sense at least one first image and at least one second image, wherein the first image is sensed by the photosensitive element through the first light path and the second image is sensed by the photosensitive element through the second light path; and
a 3D image synthesizing module for synthesizing alternate first image and second image to generate at least one 3D image.

2. The 3D image capturing device of claim 1, further comprising:
a first light valve electrically connected to the processing unit and located on the first light path; and
a second light valve electrically connected to the processing unit and located on the second light path,
wherein the 3D image sensing module enables the first light valve and the second light valve to alternately shield the first light path and the second light path, so as to enable the photosensitive element to alternately sense the first image and the second image.

3. The 3D image capturing device of claim 1, further comprising:
a central light incident hole located between the first light incident hole and the second light incident hole,
wherein the processing unit further comprises:
a planar image generating module for enabling the photosensitive element to sense a planar image through a central light path formed by the central light incident hole.

4. The 3D image capturing device of claim 3, further comprising:
a first light valve electrically connected to the processing unit and located on the first light path; and
a second light valve electrically connected to the processing unit and located on the second light path,
wherein the 3D image sensing module enables the first light valve and the second light valve to alternately shield the first light path and the second light path, so as to enable the photosensitive element to alternately sense the first image and the second image.

5. The 3D image capturing device of claim 4, wherein the processing unit further comprises:
a 3D image shielding module for simultaneously driving the first light valve and the second light valve to shield the first light path and the second light path respectively when the planar image generating module is in operation.

6. The 3D image capturing device of claim 3, further comprising:
a central light valve electrically connected to the processing unit and located on the central light path,
wherein the processing unit further comprises:
a planar image shielding module for driving the central light valve to shield the central light path when the 3D image synthesizing module is in operation.

7. The 3D image capturing device of claim 3, further comprising:
a central shielding piece, removable disposed on the central light path.

8. The 3D image capturing device of claim 3, further comprising:
a first shielding piece, removably disposed on the first light path; and
a second shielding piece, removably disposed on the second light path.

9. The 3D image capturing device of claim 1, further comprising:
a first light valve electrically connected to the processing unit and located on the first light path; and
a second light valve electrically connected to the processing unit and located on the second light path,
wherein the 3D image sensing module enables the first light valve and the second light valve to alternately shield the first light path and the second light path, so as to enable the photosensitive element to alternately sense the first image and the second image;
a central light incident hole located between the first light incident hole and the second light incident hole;
a central light valve electrically connected to the processing unit and located on the central light path,
wherein the processing unit further comprises:
a planar image generating module for enabling the photosensitive element to sense a planar image through the central light path formed by the central light incident hole;
a 3D image shielding module for simultaneously driving the first light valve and the second light valve to shield the first light path and the second light path respectively when the planar image generating module is in operation; and
a planar image shielding module for driving the central light valve to shield the central light path when the 3D image synthesizing module is in operation.

10. The 3D image capturing device of claim 1, further comprising:
a first shielding piece removably disposed on the first light path;
a second shielding piece removably disposed on the second light path;
a central light incident hole located between the first light incident hole and the second light incident hole;
a central shielding piece removably disposed on a central light path formed by the central light incident hole;
wherein the processing unit further comprising:
a planar image generating module for enabling the photosensitive element to sense a planar image through the central light path;
a 3D image shielding module for simultaneously driving the first shielding piece and the second shielding piece to be on the first light path and the second light path respectively when the planar image generating module is in operation; and
a planar image shielding module for driving the central shielding piece to be on the central light path when the 3D image synthesizing module is in operation.

11. A three-dimensional (3D) image capturing method, comprising:
is forming a first path through a first light incident hole;
forming a second light path through a second light incident hole, wherein a photosensitive element is disposed at an intersection point between the first light path and the second light path;
using the photosensitive element to alternately sense at least one first image and at least one second image, wherein the first image is sensed through the first light path, and the second image is sensed through the second light path; and
synthesizing alternate first image and second image to generate at least one 3D image.

12. The 3D image capturing method of claim 11, further comprising:
alternately shielding the first light path and the second light path, so as to enable the photosensitive element to alternately sense the first image and the second image.

13. The 3D image capturing method of claim 12, wherein the step of alternately shielding the first light path and the second light path comprises:
alternately triggering a first light valve located on the first light path and a second light valve located on the second light path, so as to alternately shield the first light path and the second light path.

14. The 3D image capturing method of claim 11, further comprising:
forming a central light path through a central light incident hole, wherein the central light incident hole is located between the first light incident hole and the second light incident hole; and
using the photosensitive element to sense a planar image through the central light path.

15. The 3D image capturing method of claim 14, further comprising:
alternately shielding the first light path and the second light path, so as to enable the photosensitive element to alternately sense the first image and the second image.

16. The 3D image capturing method of claim 15, further comprising:
simultaneously shielding the first light path and the second light path when the planar image is being sensed.

17. The 3D image capturing method of claim 14, further comprising:
shielding the central light path when the first image and the second image are being alternately sensed.

18. The 3D image capturing method of claim 14, wherein the step of shielding the central light path further comprises:
shielding the central light path by a shielding piece, a liquid crystal light valve, or a shutter.

19. The 3D image capturing method of claim 11, further comprising:
alternately shielding the first light path and the second light path, so as to enable the photosensitive element to alternately sense the first image and the second image, wherein the step of alternately shielding the first light path and the second light path further comprises:
alternately triggering a first light valve located on the first light path and a second light valve located on the second light path, so as to alternately shield the first light path and the second light path;
forming a central light path through a central light incident hole, wherein the central light incident hole is located between the first light incident hole and the second light incident hole;
using the photosensitive element to sense a planar image through the central light path;
shielding the first light path and the second light path when a planar image is being sensed; and
shielding the central light path when the first image and the second image are being alternately sensed.
